(19) United States
(12) Patent Application Publication
(10) Pub. No.: US 2012/0140256 A1
(43) Pub. Date: Jun. 7, 2012

(54) CONTROL DEVICE, COMPUTER READABLE MEDIUM, AND IMAGE FORMING DEVICE

(75) Inventors: Atsushi MORI, Kanagawa (JP); Izumi SHIROTA, Kanagawa (JP); Hideharu IWASHITA, Kanagawa (JP); Takeshi YOKOE, Kanagawa (JP); Tsuyoshi TOODA, Kanagawa (JP); Takayoshi SUZUKI, Kanagawa (JP); Katsue KOMAKI, Kanagawa (JP); Satoshi MARUYAMA, Kanagawa (JP)

(73) Assignee: FUJI XEROX CO., LTD., Tokyo (JP)

(21) Appl. No.: 13/086,731

(22) Filed: Apr. 14, 2011

(30) Foreign Application Priority Data
Dec. 2, 2010 (JP) 2010-269328

(51) Int. Cl. G06K 15/02

(52) U.S. Cl. 358/1.13

(57) ABSTRACT

A control device includes a device state changing unit, a communication unit, a communication unit, a storage unit, a storage unit state changing unit, and a reducing unit. The device state changing unit changes a state of the control device between a power saving state and a normal state. The communication unit communicates with a controlled device. The storage unit is an object of at least one of reading operation and recording operation by the communication unit. The storage unit stores at least part of information which the communication unit needs for communication with the controlled device. The storage unit state changing unit changes a state of the storage unit between a stored content holding state and a normal state in given cycles. The reducing unit reduces frequency of operation of reading and recording to the storage unit in the communication unit.

### CROSS-REFERENCE TO RELATED APPLICATIONS

This application is based upon and claims priority under 35 USC 119 from Japanese Patent Application No. 2010-269328, filed Dec. 2, 2010.

### BACKGROUND

### Technical Field

The present invention relates to a control device, a computer readable medium, and an image forming device.

### SUMMARY OF THE INVENTION

According to an aspect of the invention, a control device includes a device state changing unit, a communication unit, a communication unit, a storage unit, a storage unit state changing unit, and a restraining unit. The device state changing unit changes a state of the control device between a power saving state and a normal state. The communication unit communicates with a controlled device. The storage unit is an object of at least one of reading operation and recording operation by the communication unit and that stores at least part of information which the communication unit needs for communication with the controlled device. The storage unit state changing unit changes a state of the storage unit between a stored content holding state and a normal state in given cycles when the state of the control device is changed by the device state changing unit from the normal state into the power saving state. The reducing unit that reduces frequency of operation of reading and recording to the storage unit in the communication unit when the storage unit is in the stored content holding state in accordance with the cycles.

### BRIEF DESCRIPTION OF THE DRAWINGS

Exemplary embodiments of the invention will be described in detail based on the following figures, wherein:

FIG. 1 is a view showing a configuration example of an image forming device;

FIG. 2 is a view showing configuration of a device body 2;

FIGS. 3A and 3B are views showing an example of information stored in a control area 243 of a temporary storage unit 24;

FIG. 4 is a view showing an operation example of a calculation unit 21 and the temporary storage unit 24, when an image forming device 1 is in a power saving state;

FIG. 5 is a view showing an operation example of the calculation unit 21 and the temporary storage unit 24, when the image forming device 1 is in the power saving state;

FIG. 6 is a block diagram showing a configuration example of a function unit for controlling an external device control unit 24 in the lower power state of the image forming device 1;

FIG. 7 is a flowchart showing flow of operation of the function unit 210 upon changing into the power saving state and restoration from the power saving state, in the image forming device 1;

FIG. 8 is a view showing an operation example of the calculation unit 21 and the temporary storage unit 24 in the power saving state, in the image forming device 1;

FIGS. 9A and 9B are views for explanation of time when notification from the controlled device is processed;

FIG. 10 is a flowchart showing flow of operation of the function unit 210 upon changing into the power saving state and restoration from the power saving state, in the image forming device 1;

FIG. 11 is a flowchart showing flow of operation of the function unit 210 upon changing into the power saving state and restoration from the power saving state, in the image forming device 1;

FIG. 12 is a view showing an operation example of the calculation unit 21 and the temporary storage unit 24 in the power saving state of the image forming device 1; and

FIG. 13 is a view showing an operation example of the calculation unit 21 and the temporary storage unit 24 in the power saving state of the image forming device 1.

### DETAILED DESCRIPTION

Hereinafter, embodiments of the control device, the control program, the image forming device according to the present invention will be described in detail with reference to the accompanying drawings.

### Exemplary Embodiment 1

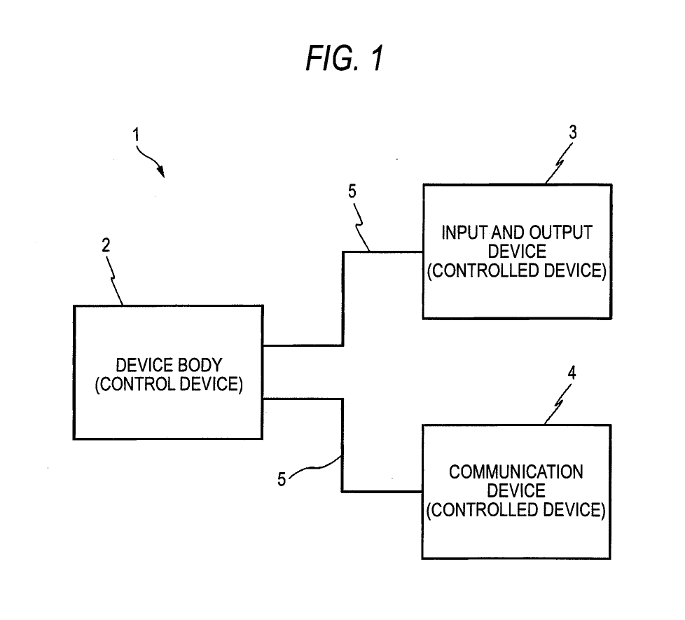

FIG. 1 is a view showing a configuration example of an image forming device. As shown in FIG. 1, the image forming device 1 is configured by a device body 2, an input and output device 3, and a communication device 4.

The device body 2 accomplishes each function except for functions of the input and output device 3 and the communication device 4. The device body 2 also operates as a control device for controlling the input and output device 3 and the communication device 4.

The input and output device 3 has a display unit and a keyboard. The input and output device 3 operates as a user interface of the image forming device 1, and also operates a controlled device controlled by the device body 2.

The communication device 4 controls connection with a network, and conducts communication of information such as printing information with a connected network. The communication device 4 also operates as a controlled device controlled by the device body 2.

The device body 2, the input and output device 3, and the communication device 4 are housed in the same housing. The input and output device 3 and the communication device 4 are connected to the device body 2 by a communication line 5 for communication, e.g., a communication line 5 in accordance with a USB standard.

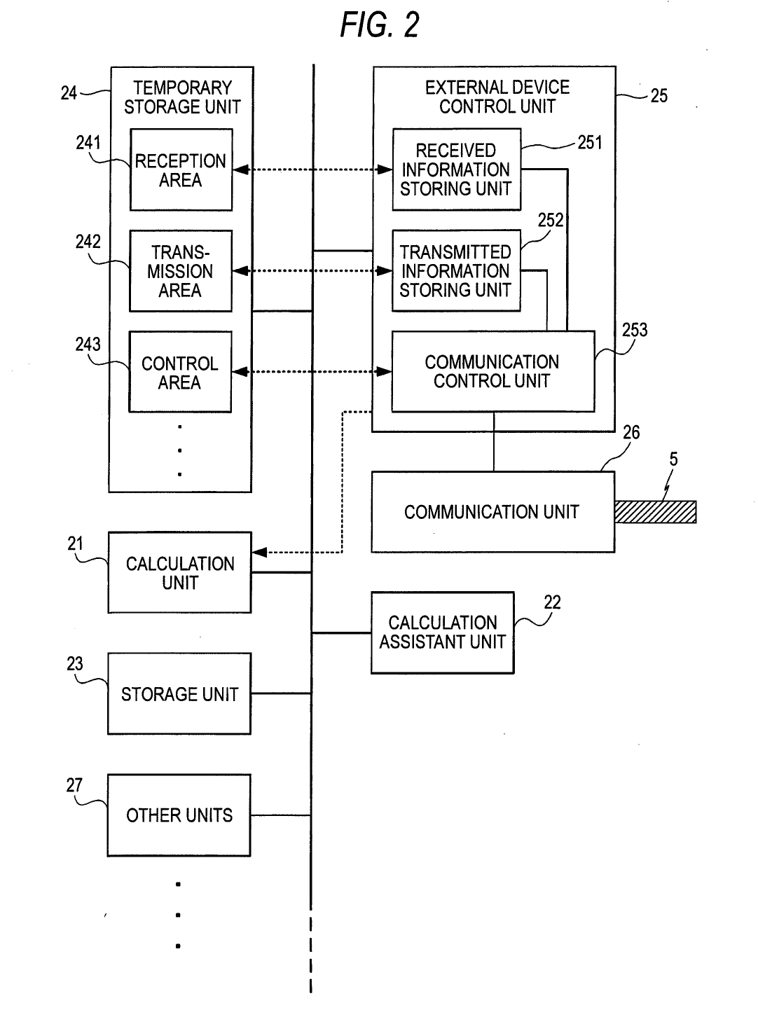

Next, configuration of the device body 2 will be described. FIG. 2 is a view showing configuration of the device body 2. Meanwhile, FIG. 2 does not illustrate configuration other than connection with the input and output device 2 or the communication device 4 and configuration to control the devices.

As shown in FIG. 2, the device body 2 has a calculation unit 21, a calculation assistant unit 22, a storage unit 23, a temporary storage unit 24, an external device control unit 25, a communication unit 26, and other units 27.

The calculation unit 21 performs a calculation process, and is realized by processors such as a CPU (Central Processing Unit).

The calculation assistant unit 22 assists the calculation unit 21, and performs processes such as generating an interrupt signal to enable the calculation unit 21 to perform an interrupting process. For example, the calculation assistant unit 22 is realized by an integrated electric circuit, or others, including a semiconductor device and others.

The storage unit 23 stores programs, setting information, or others, and is realized by a semiconductor storage device such as a ROM (Read Only Memory) and a nonvolatile memory.

The temporary storage unit 24 is used as a working area or others when the calculation unit 21 performs a calculation process, and temporarily stores information or others. For example, the temporary storage unit 24 is realized by a semiconductor storage device such as a RAM (Random Access Memory). The temporary storage unit 24 is also used when information is transmitted and received with the external device control unit 25. As such, a reception area 241, a transmission area 242, and a control unit 243 are assigned to the temporary storage unit 24.

The external device control unit 25 controls the controlled device (the input and output device 3 and the communication device 4) connected through the communication line 5 (refer to FIG. 1), and is realized by an integrated circuit including a processor or others, or a program for the processor. Assuming that the connection with the controlled device complies with the USB standard, the external device control unit 25 corresponds to a USB controller. The external device control unit 25 will be described in detail later.

The communication unit 26 is an interface to which the communication line 5 is connected. The communication unit 26 establishes a communication between the controlled device (the input and output device 3 and the communication device 4) and the external device control unit 25 through the communication line 5.

The other units 27 are other units for performing image formation. There may be a plurality of the other units. Meanwhile, if the image forming device 1 has a copy function and others, the other units 27 include a portion to perform scanning a document or others.

Hereinafter, the external device control unit 25 will be described in detail. The external device control unit 25 has a received information storing unit 251, a transmitted information storing unit 252, and a communication control unit 253.

The received information storing unit 251 temporarily stores information, which is received by the communication unit 26 from the controlled device (the input and output device 3 and the communication device 4), through the communication control unit 253. That is, the received information storing unit 251 is a storing area used as a buffer. Information stored in the received information storing unit 251 is transmitted to the reception area 241 of the temporary storage unit 24. In that case, transmission by DMA (Direct Memory Access) is performed.

The transmitted information storing unit 252 temporarily stores information, which is transmitted by the communication unit 26 to the controlled device (the input and output device 3 and the communication device 4) through the communication control unit 253. That is, the transmitted information storing unit 252 is a storing area used as a buffer. Information stored in the received information storing unit 251 is acquired from the transmission area 242 of the temporary storage unit 24. In that case, transmission by DMA is performed.

The communication control unit 253 controls the communication unit 26 to transmit and receive information with the controlled device (the input and output device 3 and the communication device 4). In the USB standard, transmission of information to the controlled device and reception of information from the controlled device are performed under control by the communication control unit 253. Even when information generated due to operation of the controlled device is received, for example, information about notification of key inputting to the input and output device 3 is received, the information is received in the form of a response to an inquiry from the communication control unit 253 to the controlled device.

As such, even in the case where no information transmitted to the controlled device exists, as well as in the case where information transmitted to the controlled device exists, the communication unit 253 needs to perform periodically transmitting and receiving information with each of the controlled devices. Accordingly, information or others regarding a schedule for communication with each of the controlled devices is stored in the control area 243 of the temporary storage unit 24. The communication control unit 253 periodically reads the information.

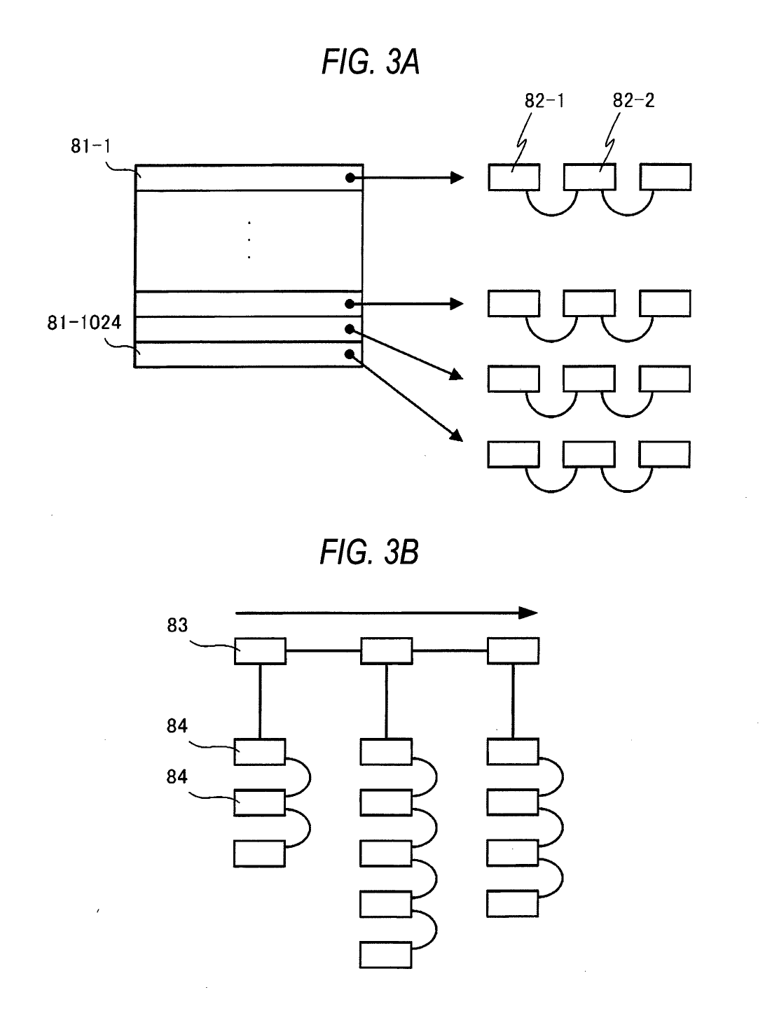

In the control area 243 of the temporary storage unit 24, information or others regarding a schedule for communication with each of the controlled devices are stored as frame lists (frame lists 81-1 to 81-1024), as shown in FIG. 3A. The frame lists are stored by the function unit realized such that the calculation unit 21 executes a driver program for operating the external device control unit 25.

Each of the frame lists 81 (81-1 to 81-1024) includes a plurality of descriptors 82 (descriptor 82-1, descriptor 82-2, and others). The frame lists 81 read by the communication control unit 253 from the control area 243 are divided into the communication control unit 253 and the descriptors 82.

The descriptors 82 include end point descriptors (ED: Endpoint Descriptor) 83 for identifying a buffer of the controlled device (the input and output device 3 and the communication device 4) to be an end point, and transfer descriptors (TD: Transfer Descriptor) 84 including information to be transmitted, a pointer for identifying information, and others. As shown in FIG. 3B, at least one transfer descriptor is associated with one end point descriptor 83. If the transfer descriptor 84 is a pointer for identifying data, the pointer is transmitted from the communication control unit 253 to the controlled device (the input and output device 3 and the communication device 4), together with the information pointed by the pointer (information read from the transmission area 242 of the temporary storage unit 24 to the transmitted information storing unit 252).

Meanwhile, since the frame lists 81, the end point descriptors 3, the transfer descriptors 84, and others are defined by a standard named as an OHCI (Open Host Controller Interface) or an ECHI (Enhanced Host Controller Interface), detailed description thereof is omitted herein.

Hereinafter, the case of changing the image forming device 1 into the power saving state will be described. In order to change the image forming device 1 into the power saving state, the power source of each of units for performing image formation as presented as the other units 27 in FIG. 2 is disconnected. Separately to the disconnection, the calculation unit 21 is controlled to periodically repeat a operating state for enabling the calculation unit 21 and a halt state for disabling the calculation unit 21.

When the calculation unit 21 is changed into the halt state, the calculation unit 21 does not perform reading or recording of information from the temporary storage unit 24, so that the temporary storage unit 24 only has to hold a stored content. Accordingly, when the calculation unit 21 is disabled, the temporary storage unit 24 is changed from a normal operation mode to a stored content holding mode operating with smaller power consumption than the normal operation mode.

Meanwhile, a self refresh mode may be adopted as the stored content holding mode.

When the calculation unit 21 is changed into the operating state, the calculation unit 21 performs reading or recording of information from the temporary storage unit 24. Accordingly, the temporary storage unit 24 is changed from the stored content holding mode into the normal operation mode.

As described above, when the image forming device 1 is changed into the power saving state, the operation mode of the temporary storage unit 24 is changed into the normal operation mode or the stored content holding mode, according to the periodically repeated operating state or halt state of the calculation unit 21.

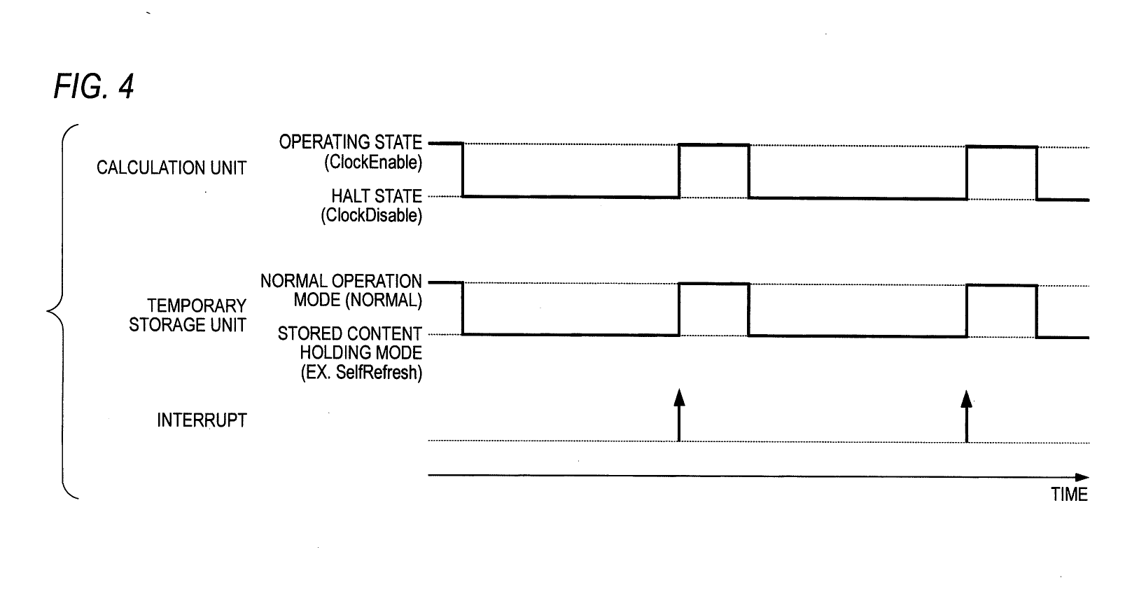

FIG. 4 is a view showing an operation example of the calculation unit 21 and the temporary storage unit 24, when the image forming device 1 is in the power saving state. As shown in FIG. 4, the calculation unit 21 periodically repeats the halt state (clock disable state) and the operating state (clock enable state). The changing from the operating state into the halt state is performed by operation of the calculation unit 21 according to a program. The calculation unit 21 is changed into the halt state after a certain time period once the calculation unit 21 becomes in the operating state. Changing from the halt state into the operating state is performed based on an interrupt signal input from the calculation assistant unit 22 into the calculation unit 21.

Even when the temporary storage unit 24 operates in the stored content holding mode, if reading or recording of information (hereinafter, referred to as “access”) occurs from the calculation unit 21, the temporary storage unit 24 operates in the normal operation mode. As such, even if the temporary storage unit 24 has operated in the stored content holding mode, if frequency of accesses to the temporary storage unit 24 increases, the effect in reducing power consumption by the operation in the stored content holding mode is low.

However, the input and output device 3, which is the controlled device, operates as a user interface of the image forming device 1. The communication device 4 receives printing information through a network. Operation of a keyboard or others by a user or reception of printing information is an event occurring even when the image forming device 1 is in the power saving state. As a result of the occurrence of the event, the image forming device 1 releases the power saving state. Accordingly, the input and output device 3 and the communication device 4, which are the controlled devices, need to operate even when the image forming device 1 is in the power saving state. The external device control unit 25, which controls the input and output device 3 and the communication device 4, also need to operate.

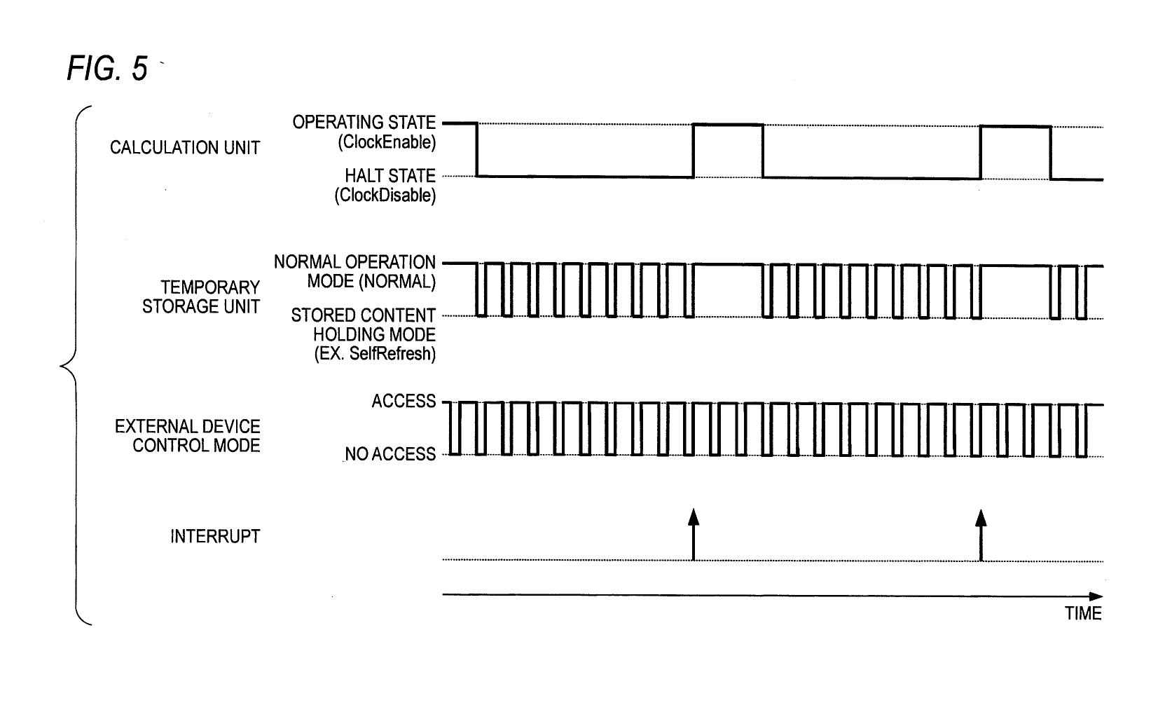

When the external device control unit 25 operates as usual, the communication control unit 253 periodically accesses the control area 243, as described above. Thus, as shown in FIG. 5, the temporary storage unit 24 frequently needs to operate in the normal operation mode, even when it operates in the stored content holding mode.

As such, in the image forming device 1, the external device control unit 25 is controlled by the function unit 210 which is realized by the calculation unit 21 executing a driver program. As a result, the number of accesses to the control area 243 is reduced, thereby lengthening the time when the temporary storage unit 24 operates in the stored content holding mode.

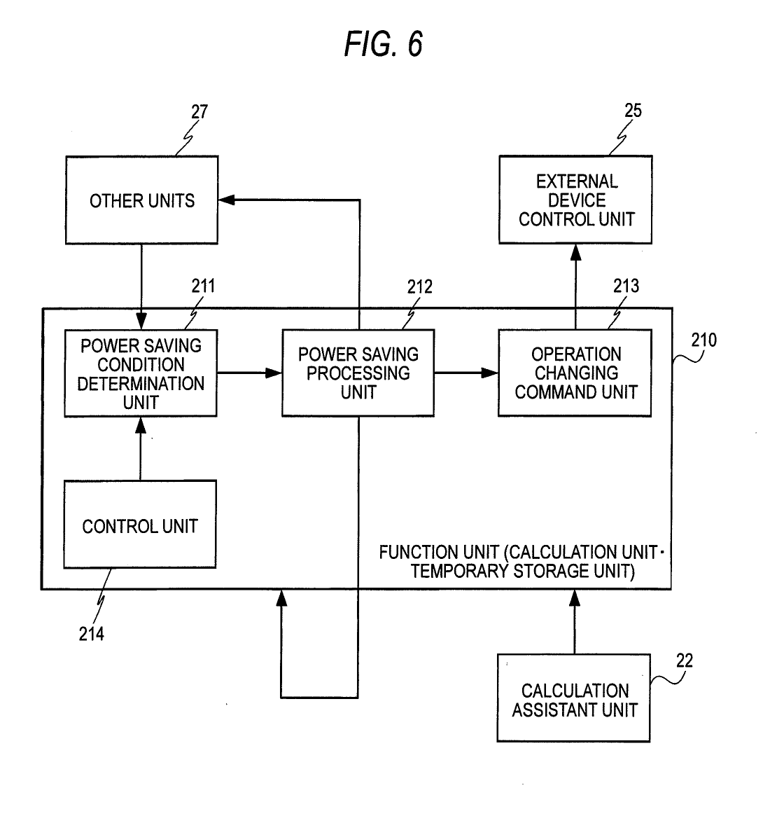

FIG. 6 is a block diagram showing a configuration example of a function unit 210 for controlling the external device control unit 25 in the power saving state of the image forming device 1.

As shown in FIG. 6, the calculation unit 21 executes a driver program to realize the function unit 210 which has a power saving condition determination unit 211, a power saving processing unit 212, and an operation changing command unit 213. Meanwhile, the function unit 210 has a control unit 214, in addition to the above components. However, the control unit 214 controls the image forming device 1 wholly. Since the function itself of the control unit 214 is not significantly different from that of a control unit of a conventional image forming device, explanation thereof is omitted herein.

The power saving condition determination unit 211 acquires an operation state or others from the other units 27 or the control unit 214 to determine whether a condition for changing the image forming device 1 into the power saving state is satisfied or not. For example, the condition may be a state that no operation or printing information is received in certain time, a state of arrival at designated time such as at night, or others. In the power saving state, the power saving condition determination unit 211 also determines whether a condition for restoring the image forming device 1 from the power saving state is satisfied or not.

If the power saving condition determination unit 211 determines that the condition for changing the image forming device 1 into the power saving state is satisfied, the power saving processing unit 212 changes each state of the other units 27, the control unit 214, and the operation changing command unit 213 into the power saving state. If the power saving condition determination unit 211 determines that the condition for restoration from the power saving state is satisfied, the power saving processing unit 212 restores each of the other units 27, the control unit 214, and the operation changing command unit 213 from the power saving state into the normal state.

If changing into the power saving state is commanded by the power saving processing unit 212, the operation changing command unit 213 changes the operation of the external device control unit 25. Specifically, access from the external device control unit 25 to the control area 243 is restrained. Frequency of access from the external device control unit 25 to the control area 243 may be reduced.

The power saving processing unit 212 also changes the function unit 210 including the power saving processing unit 212 into the power saving state. When an interrupting process is generated by the calculation assistant unit 22, the power saving state of the function unit 210 is temporally released. When the power saving state of the function unit 210 is released, the power saving condition determination unit 211 determines whether the condition for restoration from the power saving state is satisfied or not.

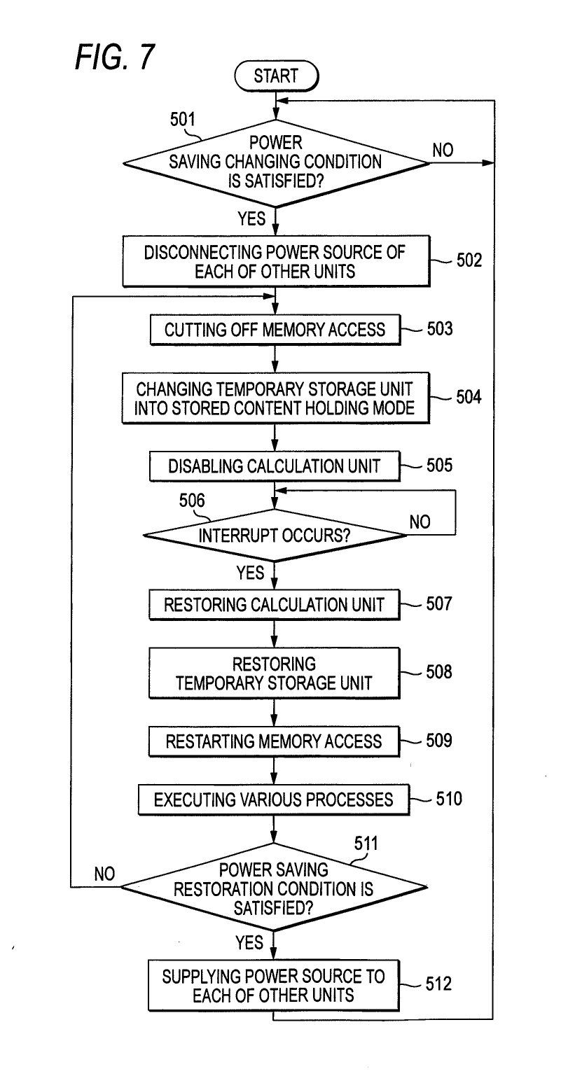

Next, operation of the function unit 210 will be described. FIG. 7 is a flowchart showing flow of operation of the function unit 210 upon changing into the power saving state and restoration from the power saving state, in the image forming device 1.

In order to enable the power saving condition determination unit 211 to determine whether the condition for changing the image forming device 1 into the power saving state is satisfied or not, in the normal state of the image forming device 1, the function unit 210 monitors the other units 27 and others. The function unit 210 continues to monitor the other units 27 and others, until the condition for changing into the power saving state is satisfied (NO in Step 501). Meanwhile, the control unit 214 also operates in the normal state during that time.

If the power saving condition determination unit 211 determines that the condition for changing the image forming device 1 into the power saving state is satisfied (YES in Step 501), the power saving processing unit 212 disconnects the power source that has been supplied to the other units 27 to disable the other units 27 (Step 502).

Subsequently, the power saving processing unit 212 requests the operation changing command unit 213 to change the state of the external device into the power saving state. In accordance with the request, the operation changing command unit 213 controls the external device control unit 25 to cut off an access from the external device control unit 25 to the temporary storage unit 24, i.e., a memory access (Step 503).

The power saving processing unit 212 changes the temporary storage unit 24 into the stored content holding mode having lower power consumption than power consumption of the normal operation mode (Step 504), and disables the operation of the calculation unit 21 (Step 505). As a result, the function unit 210 including the power saving processing unit 212 also is in the halt state.

After elapse of a certain time, when an interrupt signal is input from the calculation assistant unit 22 to the calculation unit 21 (YES in Step 506), the calculation unit 21 is restored from the halt state to the normal state to operate (Step 507), and restores the temporary storage unit 24 from the stored content holding mode to the normal operation mode (Step 508). Accordingly, the function unit 210 including the power saving condition determination unit 211, the power saving processing unit 212, and the operation changing command unit 213, and the control unit 214 is restored from the power saving state.

When the function unit 210 is restored from the power saving state, the power saving processing unit 212 requests the operation changing command unit 213 to be restored from the power saving state. In accordance with the request, the operation changing command unit 213 controls the external device control unit 25 to restart an access from the external device control unit 25 to the temporary storage unit 24, i.e., a memory access (Step 509). When there is any process required upon the interrupting process, the control unit 214 executes the required process (Step 510).

Subsequently, the power saving condition determination unit 211 determines whether the condition for restoration from the power saving state is satisfied or not. If the condition for restoration from the power saving state is not satisfied (NO in Step 511), the step processes return back to Step 503 to repeat the corresponding processes.

When the power saving condition determination unit 211 determines whether the condition for restoring the image forming device 1 from the power saving state is satisfied or not, if the condition for restoration from the power saving state is satisfied (YES in Step 511), for example, if there is input of command operation from the input and output device 3, reception of printing information by the communication device 4, or others, the external device control unit 25 restarts a memory access to the temporary storage unit 24, whereby this event is acquired by the control unit 214 through the temporary storage unit 24. Accordingly, the power saving processing unit 212 supplies a power source for supplying power to the other units 27 to operate the other units 27 (Step 512). And, returning to Step 501, the power saving processing unit 212 monitors the other units 27, in order to enable the power saving condition determination unit 211 to determine whether the condition for changing into the power saving state is satisfied or not.

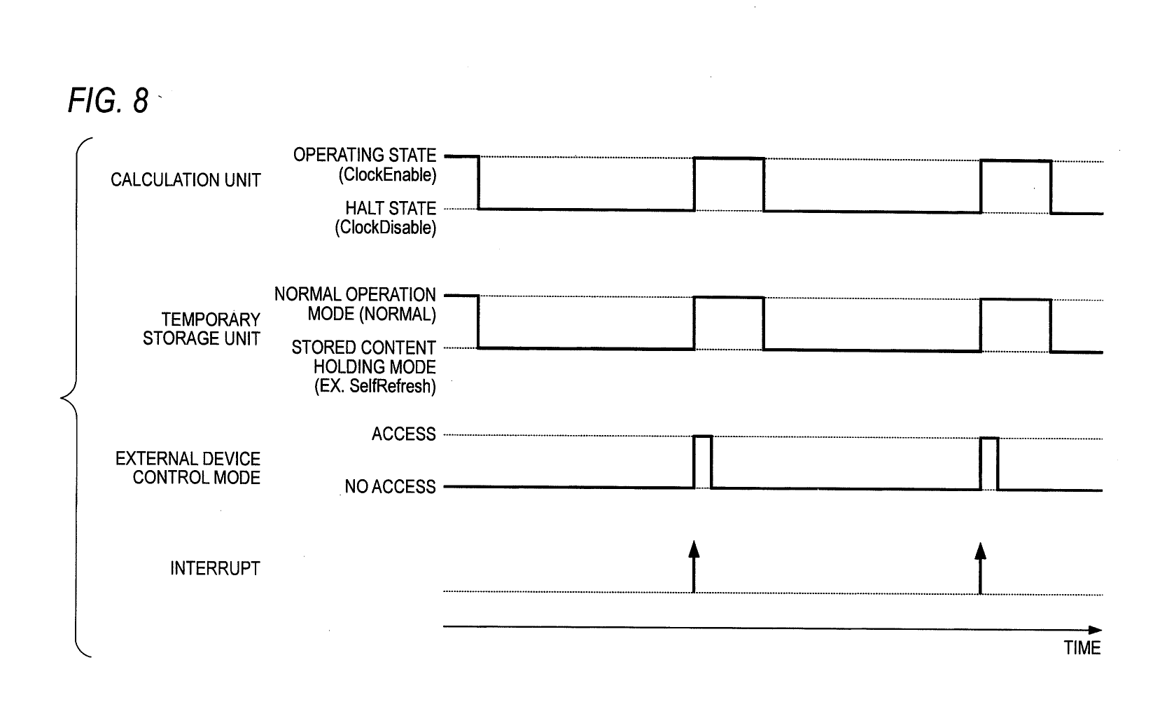

As described above, the external device control unit 25 performs control for cutting off and restarting an access to the temporary storage unit 24. As a result, as shown in FIG. 8, when the calculation unit 21 is in the halt state (clock disable), an access from the external device control unit 25 to the temporary storage unit 24 is cut off. Accordingly, the temporary storage unit 24 operates in a stored content holding mode. When the temporary storage unit 24 operates in the normal operation mode in the operating state (clock enable) of the calculation unit 21, the external device control unit 25 accesses the temporary storage unit 24.

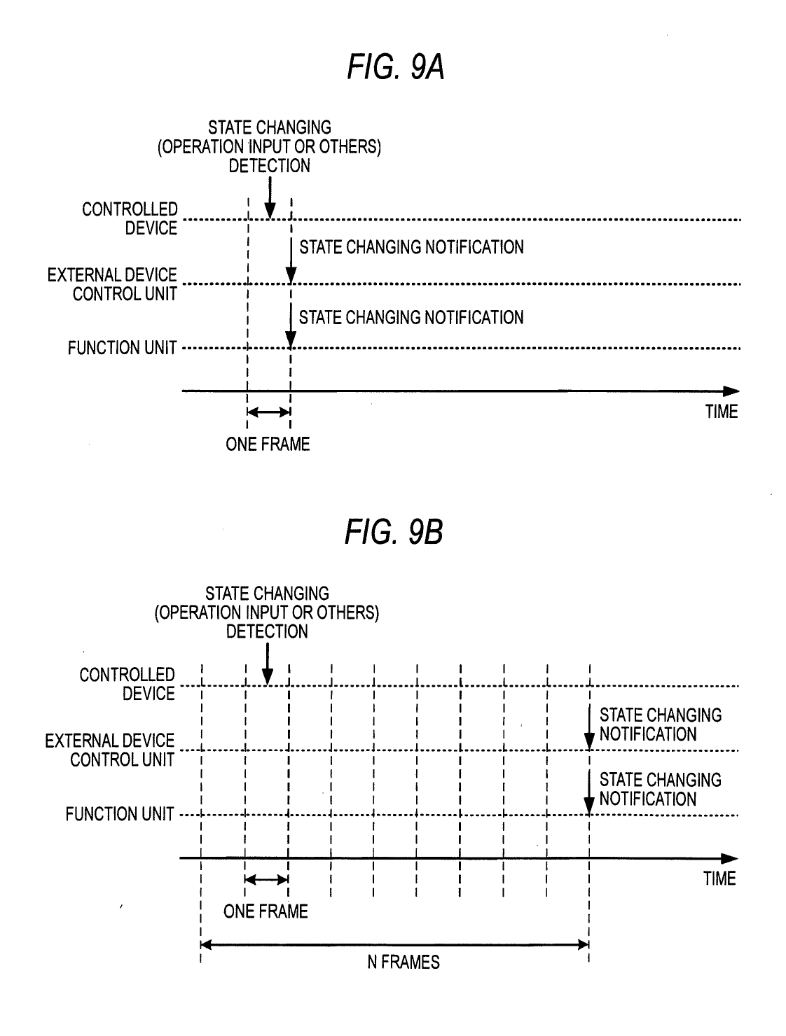

If there is input of command operation from the input and output device 3, reception of printing information by the communication device 4 or others, in the normal state, it is possible to immediately detect and respond to them through the interrupting process, as shown in FIG. 9A. (Strictly speaking, a delay of time as long as the maximum time required for processing one frame from the frame lists presented in FIG. 3A occurs.) However, in the power saving state, as shown in FIG. 9B, a delay of time corresponding to the maximum power saving cycle of the calculation unit 21 occurs. Accordingly, if the power saving cycle of the calculation unit 21 is time required for processing N frames, processes are delayed as long as the maximum N frames.

### Exemplary Embodiment 2

Exemplary Embodiment 2 describes lengthening the time when the temporary storage unit 24 operates in the stored content holding mode, by controlling the external device control unit 25 to reduce the number of accesses to the control area 243, in the same power saving state as the image forming device 1 described in Exemplary Embodiment 1. Meanwhile, since the image forming device described in Exemplary Embodiment 2 is different from the image forming device 1 described in Exemplary Embodiment 1 only in terms of operation of the function unit 210, the configuration or others of the image forming device 1 of Exemplary Embodiment 2 will not be described. Exemplary Embodiment 2 will only describe the operation of the function unit.

Since Exemplary Embodiment 2 will use the drawings referenced in Exemplary Embodiment 1, Exemplary Example 2 will use the same reference numerals as used in Exemplary Embodiment 1. However, the operation of the function unit 210 in Exemplary Embodiment 2 is different from that in Exemplary Embodiment 1.

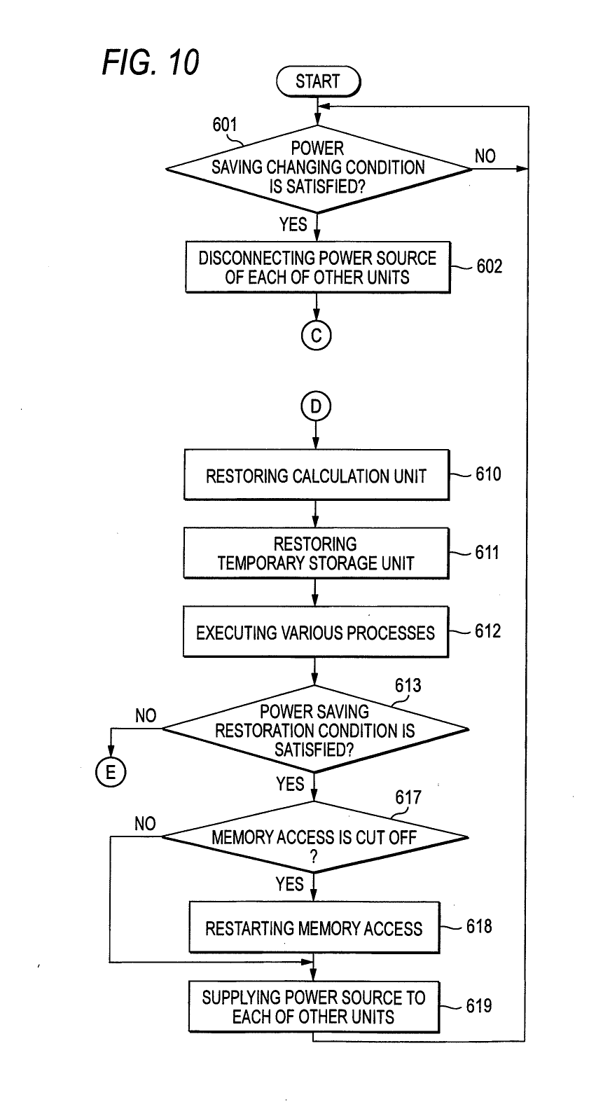

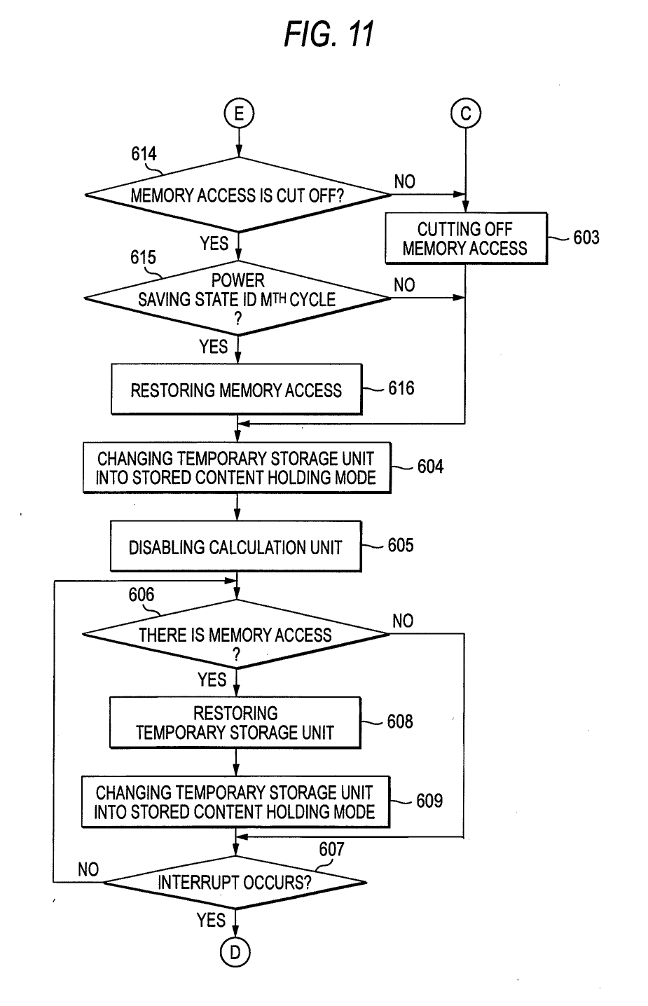

FIGS. 10 and 11 are flowcharts showing flow of operation of the function unit 210 upon changing into the power saving state and restoration from the power saving state, in the image forming device 1.

In order to enable the power saving condition determination unit 211 to determine whether the condition for changing into the power saving state is satisfied or not, in the normal state, the function unit 210 monitors the other units 27. The function unit 210 continues to monitor the other units 27, until the condition for changing into the power saving state is satisfied (NO in Step 601). Meanwhile, the control unit 214 also operates in the normal state during that time.

If the power saving condition determination unit 211 determines whether the condition for changing into the power saving state is satisfied (YES in Step 601), the power saving processing unit 212 disconnects the power source that has been supplied to the other units 27 to disable the other units 27 (Step 602).

Subsequently, the power saving processing unit 212 requests the operation changing command unit 213 to be changed into the power saving state. In accordance with the request, the operation changing command unit 213 controls the external device control unit 25 to disable an accesses from the external device control unit 25 to the temporary storage unit 24, i.e., a memory access (Step 603).

The power saving processing unit 212 changes the temporary storage unit 24 into the stored content holding mode having lower power consumption than the normal operation mode (Step 604), and disables the operation of the calculation unit 21 (Step 605). As a result, the function unit 210 including the power saving processing unit 212 is also in the halt state.

Thereafter, if there has been a memory access to the temporary storage unit 24 (YES in Step 606) during the time when an interrupt signal is input from the calculation assistant unit 22 to the calculation unit 21 (NO in Step 606, and NO in Step 607), the temporary storage unit 24 is restored from the stored content holding mode to the normal operation mode (Step 608). When the memory access is finished, the temporary storage unit 24 is changed again into the stored content holding mode having lower power consumption than the normal operation mode (Step 609). Meanwhile, a memory access from the external device control unit 25 does not occur, in the state that a memory access from the external device control unit 25 to the temporary storage unit 24 is cut off.

If there has been a memory access to the temporary storage unit 24, once the temporary storage unit 24 is restored from the stored content holding mode to the normal operation mode (YES in Step 606, and Step 608), even if the memory access is finished, the temporary storage unit 24 remains in the normal operation mode. That is, the process of Step 609 may be omitted. Accordingly, it is possible to use a device capable of being changed into the normal operation mode and the stored content holding mode only through control by the function unit 210, i.e., software control, as the temporary storage unit 24.

Thereafter, when an interrupt signal is input from the calculation assistant unit 22 to the calculation unit 21 (YES in Step 607), the calculation unit 21 is restored from the halt state to operate (Step 610). The temporary storage unit 24 is restored from the stored content holding mode to the normal operation mode (Step 611). Accordingly, the function unit 210 including the power saving condition determination unit 211, the power saving processing unit 212, the operation changing command unit 213, and the control unit 214 is restored from the power saving state. In that case, if there is any process required upon the interrupting process, the control unit 214 executes the process (Step 612).

Thereafter, the power saving condition determination unit 211 determines whether the condition for restoring the image forming device 1 from the power saving state is satisfied or not. If the condition for restoring from the power saving state is not satisfied (NO in Step 613), the image forming device 1 is not restored from the power saving state.

At this time, if a memory access from the external device control unit 24 to the temporary storage unit 24 is cut off (YES in Step 614), and a circle after changing into the power saving state is an M^{th} cycle (YES in Step 615), the operation changing command unit 213 controls the external device control unit 25 to restart a memory access from the external device control unit 25 to the temporary storage unit (Step 616). The power saving processing unit 212 changes the temporary storage unit 24 into the stored content holding mode having lower power consumption than the normal operation mode (Step 604), disables the operation of the calculation unit 21 (Step 605), and repeats the follow-up processes. In the state that a memory access from the external device control unit 25 to the temporary storage unit 24 is restarted, a memory access from the external device control unit 25 to the temporary storage unit 24 may occur, during the time when an interrupt signal is input from the calculation assistant unit 22 to the calculation unit 21 (NO in Step 606 and NO in Step 607). Thus, if there is a memory access to the temporary storage unit 24 (YES in Step 606), the temporary storage unit 24 is restored from the stored content holding mode to the normal operation mode (Step 608). If the memory access is finished, the temporary storage unit 24 is changed again into the stored content holding mode (Step 609).

As to the cycle of the power saving state determined in Step 614, one cycle is from the restoration of the calculation unit 21 in Step 610 until the re-restoration of the calculation unit 21 in Step 610. When the cycle reaches a predetermined M^{th} cycle, the next cycle is separately counted as a first cycle. As to counting cycles, an initial cycle per changing into the power saving state may be counted as a first cycle, or cycles may be continuously counted, regardless of changing into or release of the power saving state.

In the case where the power saving state has been maintained (NO in Step 613), if a memory access from the external device control unit 25 to the temporary storage unit is restarted (YES in Step 614), the operation changing command unit 213 controls the external device control unit 25 to cut off a memory access from the external device control unit 25 to the temporary storage unit 24 (Step 603). The power saving processing unit 212 changes the temporary storage unit into the stored content holding mode having lower power consumption than the normal operation mode (Step 604), disables the operation of the calculation unit 21 (Step 605), and repeats the follow-up processes.

In the case where the power saving state has been maintained (NO in Step 613), even if a memory access from the external device control unit 25 to the temporary storage unit 24 is cut off (YES in Step 614), if the cycle after changing into the power saving state has not been the M^{th} cycle (NO in Step 615), control of the external device control unit 25 is not performed. Instead, the power saving processing unit 212 changes the temporary storage unit 24 into the stored content holding mode (Step 604), disables the operation of the calculation unit 21 (Step 605), and repeats the follow-up processes.

The external device control unit 25 is controlled such that, in the power saving state, a memory access from the external device control unit 25 to the temporary storage unit 24 is performed for only one cycle from the M cycles of the power saving state.

In the case where the power saving condition determination unit 211 determines that the condition for restoration from the power saving state is satisfied (YES in Step 613), in the state that the function unit 210 is restored from the power saving state, if a memory access from the external device control unit 25 to the temporary storage unit is cut off (YES in Step 617), the operation changing command unit 213 controls the external device control unit 25 to restart a memory access from the external device control unit 25 to the temporary storage unit 24 (Step 618). If a memory access from the external device control unit 25 to the temporary storage unit 24 is not cut off (NO in Step 617), the power saving processing unit 212 supplies a power source for supplying power to the other units 27 to operate the other units 27 (Step 619). And, returning back to the process of Step 601, the power saving process unit 212 monitors the other units 27 and others, in order to enable the power saving condition determination unit 211 to determine whether the condition for changing into the power saving state is satisfied or not.

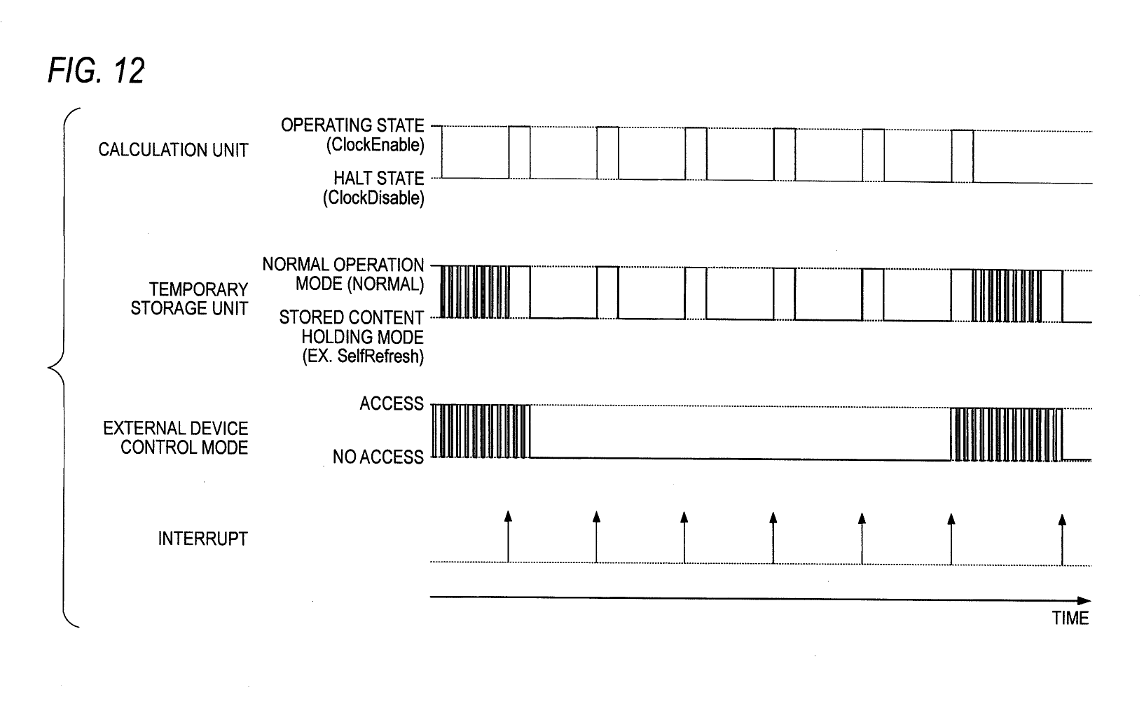

As described above, an access from the external device control unit 25 to the temporary storage unit 24 is controlled to be cut off or restarted, such that as shown in FIG. 12, the external device control unit 25 accesses the temporary storage unit 24 in one cycle of the M cycles, during the time when the calculation unit 21 repeats the halt state and the operating state. At other times, since an access from the external device control unit 25 to the temporary storage unit 24 is cut off, the temporary storage unit 24 operates in the stored content holding mode. Meanwhile, in FIG. 12, M=6.

When an access from the external device control unit 25 to the temporary storage unit 24 is controlled to be cut off or restarted, the M cycles may be predetermined. At least two or three cycles of the M cycles may be a time period, during which an access from the external device control unit 25 to the temporary storage unit 24 is cut off.

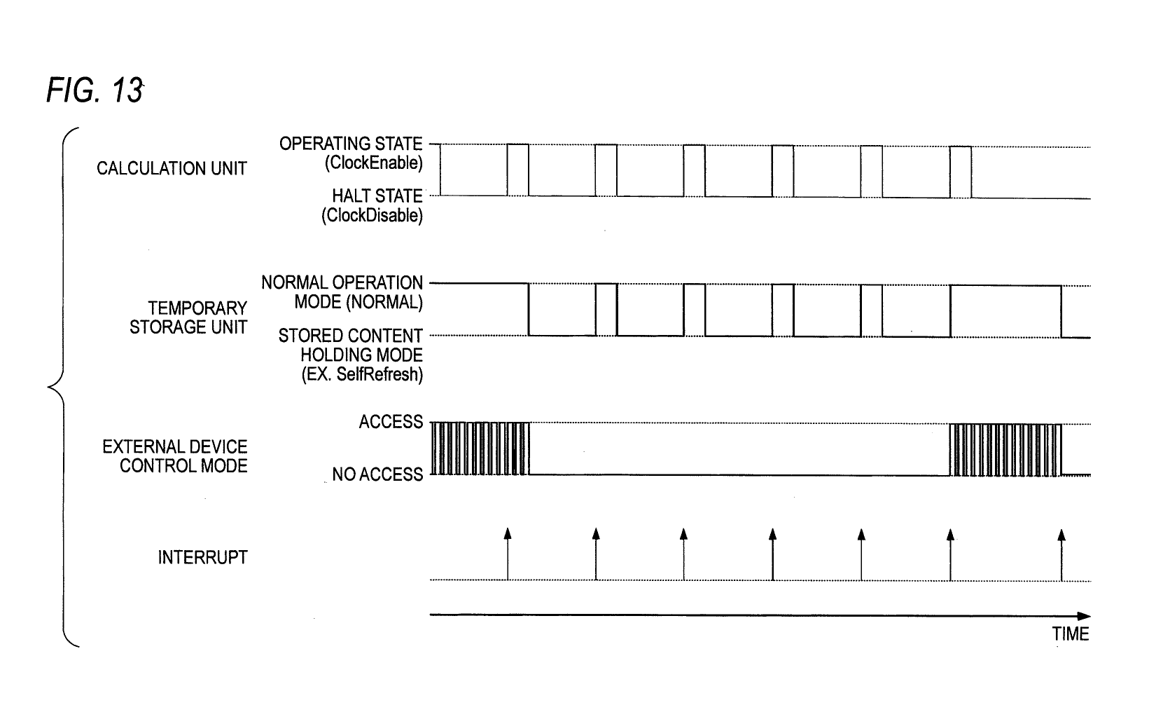

If the process of Step 609 described above has been omitted, the temporary storage unit 24 does not operate as shown in FIG. 12 and operates as shown in FIG. 13. In that case, the temporary storage unit 24 operates in the stored content holding mode, except for one cycle of the M cycles, during that time when the calculation unit 21 repeats the halt state and the operating state.

The same effect as that in the exemplary embodiments that have been described may also be obtained, by providing a storing medium, in which a program of software for accomplishing the functions of the exemplary embodiments described above is recorded, such that a communication device or others to read the program stored in the storing medium to execute the program. As the storing medium for proving a program, for example, a CD-ROM (Compact Disk Read Only Memory), a DVD (Digital Versatile Disk), and an SD card (Secure Digital memory card), or others may be used. The program may be provided by using a server (computer device) for providing a program.

In the exemplary embodiments that have been described, the image forming device has been described as an embodiment of the present invention. However, the same configuration as described in the exemplary embodiments may be applied to a device other than the image forming device, for example, an image scanning device such as a scanner, if the device is configured by a control device (device body 2) and a controlled device (the input and output device 3, and the communication device 4).

In the above embodiments, access from the external device control unit 25 to the control area 243 is restrained under a given condition. That is, the number of times of access from the external device control unit 25 to the control area 243 becomes zero under the given condition. However, this is mere example of reducing of frequency of the access. Needless to say, frequency of access from the external device control unit 25 to the control area 243 may be reduced so that the number of times of access dose not becomes zero.

The foregoing description of the exemplary embodiment of the present invention has been provided for the purpose of illustration and description. It is not intended to be exhaustive or to limit the invention to the precise forms disclosed. Obviously, many modifications and various will be apparent to practitioners skilled in the art. The embodiments were chosen and described in order to best explain the principles of the invention and its practical application, thereby enabling other skilled in the art to understand the invention for various embodiments and with the various modifications as are suited to the particular use contemplated. It is intended that the scope of the invention be defined by the following claims and their equivalents.

### DESCRIPTION OF REFERENCE NUMERALS

1 image forming device
2 device body
3 input and output device
4 communication device
5 communication line
21 calculation unit
22 calculation assistant unit
23 storage unit
24 temporary storage unit
25 external device control unit
26 communication unit
27 other units
81-1 to 81-1024 frame lists
82-1, 82-2 descriptors
83 end point descriptors
84 transfer descriptors
211 power saving condition determination unit
212 power saving processing unit
213 operation changing command unit
214 control unit
241 reception area
242 transmission area
243 control area
251 reception information storing unit
252 transmission information storing unit
253 communication control unit

What is claimed is:

1. A control device comprising:
a device state changing unit that changes a state of the control device between a power saving state and a normal state;
a communication unit that communicates with a controlled device;
a storage unit that is an object of at least one of reading operation and recording operation by the communication unit and that stores at least part of information which the communication unit needs for communication with the controlled device;
a storage unit state changing unit that changes a state of the storage unit between a stored content holding state and a normal state in given cycles when the state of the control device is changed by the device state changing unit from the normal state into the power saving state, and
a reducing unit that reduces frequency of operation of reading and recording to the storage unit in the communication unit when the storage unit is in the stored content holding state in accordance with the cycles.

2. The control device according to claim 1,
wherein the storage unit state changing unit changes the reducing unit into a halt state or a operating state in synchronization with changing of the storage unit state,
the reducing unit reduces the frequency of the operation of reading and recording to the storage unit in the communication unit or releases the reducing during the operating state, and
the reducing unit reduces the frequency of the operation of reading and recording to the storage unit in the communication unit when the storage unit is in the stored content holding state.

3. The control device according to claim 1,
wherein the storage unit state changing unit changes the reducing unit into a halt state or a operating state in synchronization with changing of the storage unit,
the reducing unit reduces the frequency of the operation of reading and recording to the storage unit in the communication unit or releases the reducing during the operating state, and
the reducing unit reduces the frequency of the operation of reading and recording to the storage unit in the communication unit during at least one of the plurality of cycles.

4. A computer readable medium storing a program causing a computer to execute a process for controlling a control device, the process comprising:
changing a state of the control device between a power saving state and a normal state;
communicating with a controlled device;
changing a state of a storage unit between a stored content holding state and a normal state in given cycles when the state of the control device is changed from the normal state into the power saving state, the storage unit being an object of at least one of reading operation and recording operation in the communication step and storing at least part of information which is needed in the communicating step for communication with the controlled device; and
reducing frequency of the operation of reading and recording to the storage unit in the communication step when the storage unit is in the stored content holding state in accordance with the cycles.

5. The computer readable medium according to claim 4,
wherein a state of the reducing step is changed into a halt state or a operating state in synchronization with changing of the storage unit state,
the reducing of the frequency of the operation of reading and recording to the storage unit in the communication step is executed or released during the operating state, and
the reducing of the frequency of the operation of reading and recording to the storage unit in the communication step is executed when the storage unit is in the stored content holding state.

6. The computer readable medium according to claim 4,
wherein a state of the reducing step is changed into a halt state or a operating state in synchronization with changing of the storage unit state,
the reducing of the frequency of the operation of reading and recording to the storage unit in the communication step is executed or released during the operating state, and
the reducing of the frequency of the operation of reading and recording to the storage unit in the communication step is executed during at least one of the plurality of cycles.

7. An image forming apparatus comprising:
a control device; and
a controlled device that is controlled by the control device,
wherein the control device includes:
a device state changing unit that changes a state of the control device between a power saving state and a normal state;
a communication unit that communicates with the controlled device;
a storage unit that is an object of at least one of reading operation and recording operation by the communication unit and that stores at least part of information which the communication unit needs for communication with the controlled device;
a storage unit state changing unit that changes a state of the storage unit between a stored content holding state and a normal state in given cycles when the state of the control device is changed by the device state changing unit from the normal state into the power saving state, and
a reducing unit that reduces frequency of operation of reading and recording to the storage unit in the communication unit when the storage unit is in the stored content holding state in accordance with the cycles.
